(19) United States
(12) Patent Application Publication
(10) Pub. No.: US 2022/0410203 A1
(43) Pub. Date: Dec. 29, 2022

(54) APPLICATION OR FILM FORMATION METHOD FOR PARTICULATE MATTER

(71) Applicant: MTEK-SMART CORPORATION, Yokohama-shi, Kanagawa (JP)

(72) Inventor: Masafumi MATSUNAGA, Yokohama-Shi (JP)

(73) Assignee: MTEK-SMART CORPORATION, Yokohama-Shi, Kanagawa (JP)

(21) Appl. No.: 17/781,644

(22) PCT Filed: Nov. 25, 2020
(86) PCT No.: PCT/JP2020/043839

§ 371 Date: Jun. 1, 2022

(30) Foreign Application Priority Data
Dec. 2, 2019 (JP) 2019-218378

(51) Int. Cl. B05D 1/10; B05D 3/04; B05B 7/20; H01M 4/64; H01M 4/62

(52) U.S. Cl. CPC B05D 1/10; B05D 3/0493; B05B 7/20; H01M 4/64; H01M 4/621

(57) ABSTRACT

[Problem] Upon application or film formation of a particulate matter to/on an object, the particulate matter moving with a speed is heated in a time duration from a suction port for particulate matter to the object, thereby softening or melting at least some of the particulate matter when the particulate matter is applied to the object.

[Solution] A particulate matter is heated by means of induction heating or laser in a time duration from a suction port for particulate matter to an object, so that at least some of the particulate matter is softened or melted at a relatively low temperature on the object in synergy with the collision energy of the particulate matter with the object, thereby enabling the application or film formation of the particulate matter.

### TECHNICAL FIELD

The present invention relates to an application or film formation method for a particulate matter on an object.

The particulate matter of the present invention contains inorganics, organics, compounds thereof, or ceramics, or a mixture thereof or the like can be used, and the shape, material, and size are not limited. In addition, many macropores, mesopores, micropores or the like are formed in short fibers such as nanofibers and single-walled carbon nanotubes, or nano-level or micrometer-level particles, or the pores are through holes and their structures are also included. A dry particulate matter may be used for application or film formation to/on an object, or the particulate matter may be mixed with a solvent or the like into a powder slurry, which is then micronized by fine droplets or sprays or the like and transferred for application or film formation. In the case of a slurry, the directly sprayed fine particles may be moved, but it is also possible to suck and move the dried particulate matter once applied to another substrate. The application means at this time includes, but is not limited to, a dispenser, a slot nozzle, atomized particle application, electrostatic atomized particle application, continuous or pulsed spray, electrostatic spray, inkjet, screen spray, a screen printing method, etc.

In addition, the transfer means and application or film-formation application for the particulate matter to/on an object also include an ejector method, a vacuum suction method (aerosol deposition method: AD method), a thermal spraying method such as a cold spray or warm spray method, or a combination thereof, etc., but any means can be used.

In addition, the number, shape, material, and size of the substrate and the object are not limited.

### BACKGROUND ART

Conventionally, in the application of particulate matter, the particulate matter is filled in a hopper, gas flows out of the porous plate at the lower part of the hopper to fluidize the particulate matter (fluidization method), and the particulate matter is sucked by an ejector pump, pumped and ejected from a spray gun in a desired pattern and applied. However, this method is a rough management method as long as the coating could be covered with a reasonable average film thickness and a minimum film thickness. A method such as JP H07-172575A as invented and proposed by the present inventor has been adopted for transporting and coating the particulate matter requiring more precision. In general powder coating, the object to be coated is grounded, and the powder coating material is electrostatically charged by corona discharge or friction and applied.

In the field of film formation of metals and ceramics, in the various thermal spraying methods, a film is formed by colliding particles with an object at high speed while melting them at a high temperature with flame or plasma. Recently, a thermal spraying method called cold spray or warm spray, in which a film is formed at a relatively low temperature, has also been proposed.

In addition, in the AD method for forming a film at a lower temperature, the particulate matter is fluidized by the fluidization method used in the general coating with argon gas or the like, the fluidized gas-powder mixture is moved to a vacuum chamber having an object by differential pressure, and collides with the object to form a film.

Patent Literature 1 is a pulsed spray method for particulate matter, which is proposed by the present inventor for stabilizing the application amount.

In Patent Literature 2, the present inventor has also invented a method in which a particulate matter is filled on a screen such as a rotary screen, separated from the opposite side of the filled surface by vibration, compressed gas, or the like, and applied to an object to be coated.

As methods for stabilizing the transferring amount of the particulate matter, for example, the above-mentioned JP H07-172575A invented by the present inventor and a method for supplying the particulate matter in a volumetric manner by a micro feeder method have been generally known.

In the aerosol deposition method as disclosed in Non-Patent Literature 1 or the like, ceramics or the like is melted in a particulate matter state at a low temperature to form a film, so that it does not require expensive and complicated large-scale equipment. In addition, since it is possible to form a film without sublimating important components, it is in the limelight as an alternative new method in various fields that require the formation of electrodes for all-solid-state batteries, which have been attracting attention recently, or the like, and the formation of dry films.

In the present invention, the method of Patent Literature 1 can be applied. In order to stabilize the suction of the particulate matter, for example, the ejector pressure is set as high as 0.3 MPa or more and the compressed gas of the ejector is opened and closed in a pulsed manner to suck the particulate matter in a pulsed manner, the particulate matter is moved in a pulsed manner, and the pulse cycle selected from 1 to 1000 cycles and the pulsed opening/closing time in milliseconds are controlled, so that an arbitrary application amount can be accurately applied. It can be replaced not only in the general coating field, but also in the electronics field where plating is required, as an improvement of the AD method, further as an alternative to some or all of the thermal spraying methods such as the cold spray method.

Since this method can eject the ejector gas in a pulsed manner, the total gas flow rate of the gas-powder mixture is small and the coating efficiency can also be increased.

In Patent Literature 2, since the supply is performed in a volumetric manner, the stability of supply can be expected to be higher than that of Patent Literature 1. The bulk specific gravity can be made constant by filling the slurry. When filling the particulate matter, the bulk density can be made constant and the filling weight can be stabilized by adding vibration, particularly ultrasonic vibration or the like. As an example of this application, innumerable regular recesses are provided, or one side of the through hole is closed with a breathable substrate smaller than the particle size of the particulate matter to allow only ultrafine powder or gas to pass through, so that the through hole can be filled with the particulate matter having a constant bulk specific gravity.

On the other hand, the micro feeder method and the above-mentioned literature invented by the present inventor can be suitably applied to the present invention if the bulk specific gravity is controlled to be constant by adding vibration to the volumetric transfer portion or the like.

In addition, in the aerosol deposition as disclosed in Non-Patent Literature 1, etc., a film can be formed on an object by setting the object in a chamber of high degree of vacuum of e.g. about 0.4 to 2 Torr, fluidizing the particulate matter in a flow tank by gas, and transferring the particulate matter of ceramics or the like having diameters of about 0.08 to 2 micrometers by energy of differential pressure higher than 50 kPa to cause them to collide on the object at a speed higher than 150 m/sec. However, especially the hard particulate matter having a relatively large particle size rebounds on the object and has an extremely low adhesion rate. The particulate matter having a small particle size is also affected by the gas flow moving together in the flow path, and as described above, the particulate matter having a particularly large particle size tends to be difficult to soften or melt and to be difficult to adhere.

### CITATION LIST

### Patent Literature

Patent Literature 1: JP S62-011574A
Patent Literature 2: JP H05-76819A

### Non-Patent Literature

Non-Patent Literature 1: AIST homepage

### SUMMARY OF INVENTION

### Technical Problem

It has been a problem to soften at least some of the particulate matter and to apply or form a film with as much as possible and a stable application weight per unit area on an object. The nano-level particulate matter of metals or the like are well known in the industry for their characteristic of lower melting point than ordinary metals. In addition, it is known that the nano-level, particularly submicron particulate matter can collide with an object in a vacuum at a high speed to form a film at a low temperature, even if they are oxide-based ceramic particles. However, when the particle size reaches the micron level, it bounces off the object and the adhesion rate is very poor. The fact that it does not adhere means that it will not be softened or melted until the particulate matter is deformed.

### Solution to Problem

The present invention has been made to solve the above problems, and an object of the present invention is to provide a method for stabilizing the application weight per unit area and softening at least some of the particulate matter to enable the application or film formation on an object.

According to the present invention, there is provided an application or film formation method for a particulate matter by pumping a particulate matter or sucking the particulate matter from a suction port, transferring the particulate matter, ejecting the particulate matter from an ejection port toward an object, and softening at least some of the particulate matter to enable the application or film formation on the object, including:

a step of providing a pumping means or a suction port for the particulate matter and an ejection port for the particulate matter, the ejection port communicating with the pumping means or the suction port,

a step of transferring the particulate matter by differential pressure between the pumping means or the suction port and the ejection port to eject the particulate matter from the ejection port toward the object,

a step of keeping ejection weight per second of the particulate matter within ±5% of a set value,

a step of setting the object downstream of the ejection port, and

a step of providing a heating means for the particulate matter between the pumping means or the suction port and the object,

wherein at least some of the particulate matter colliding with the object is at least softened or melted.

According to the present invention, there is provided an application or film formation method for a particulate matter, wherein at least the ejection port for particulate matter and the object are arranged under vacuum, so that the differential pressure is generated between the ejection port and the suction port or the pumping means for particulate matter.

According to the present invention, there is provided an application or film formation method for a particulate matter, wherein the particulate matter is transferred or ejected in a pulsed manner.

According to the present invention, there is provided an application or film formation method for a particulate matter, wherein the particulate matter to be transferred is at least one selected from: those fluidized as a gas-powder mixture; those for which a slurry including the particulate matter and at least a solvent is formed, and finely dropletized or micronized by a fine particle generator; those applied on a substrate in advance; and those filled in a body provided with a recess or a through hole in advance.

According to the present invention, there is provided an application or film formation method for a particulate matter, wherein a branching means provided with a branch port is installed upstream of the ejection port for particulate matter, and surplus gas is discharged from the branch port while the particulate matter is ejected from the ejection port toward the object.

According to the present invention, there is provided an application or film formation method for a particulate matter, wherein the suction port or the pumping means for particulate matter is installed in a first vacuum chamber, at least the object and the ejection port are installed in a second vacuum chamber, and degree of vacuum in the second vacuum chamber is high.

According to the present invention, there is provided an application or film formation method for a particulate matter, wherein the particulate matter on the substrate or the particulate matter filled in the body is mixed by adding at least a solvent to the particulate matter to form a slurry, then applied or filled and dried.

According to the present invention, there is provided an application or film formation method for a particulate matter, wherein the heating means for particulate matter is at least one selected from laser, electron beam, microwave, induction heating, plasma, flame, far infrared ray and a heater.

According to the present invention, there is provided an application or film formation method for a particulate matter, wherein the object is heated at least when the particulate matter is ejected.

According to the present invention, there is provided an application or film formation method for a particulate matter, wherein the branch port and the ejection port are installed under vacuum, the particulate matter between the ejection port for particulate matter and the object is heated with the heating means for particulate matter, or only the surface of the particulate matter applied to the object is heated with the heating means, and at least the particulate matter being laminated is softened or melted.

According to the present invention, there is provided an application or film formation method for a particulate matter, wherein the particulate matter is composed of a mixture of multiple kinds of particulate matter.

According to the present invention, there is provided an application or film formation method for a particulate matter, wherein the particulate matter contains short fibers, and multiple kinds of particulate matter are prepared, each of which is provided with an independent pumping means or suction port and an independent ejection port for particulate matter, and each of the particulate matter is mixed downstream of the ejection port, or ejected to the object with a time difference, or ejected so as to laminate at different positions, and laminated.

According to the present invention, there is provided an application or film formation method for a particulate matter, wherein the object is selected from a collector for a secondary battery, a positive electrode or negative electrode layer, a separator, and a polymer electrolyte layer.

According to the present invention, there is provided an application or film formation method for a particulate matter, wherein the object is selected from a collector for an all-solid-state battery, a positive electrode or negative electrode layer, and an electrolyte layer, and the plurality of particulate matter also contain short fibers and are selected from active material particles for a positive electrode or a negative electrode, electrolyte particles, conductive assistants, and binders.

According to the present invention, there is provided an application or film formation method for a particulate matter, wherein a layer composed of a binder or a mixture of a binder and the particulate matter is formed on the object in advance.

According to the application or film formation method for a particulate matter to/on an object of the present invention, at least some of the particulate matter is softened or melted on the object, thereby the particulate matter is applied or a film is formed, the adhesion is improved and the interfacial resistance can be reduced, therefore the overall performance of the battery can be improved. Needless to say, all of the particulate matter can be softened or melted. Furthermore, since the equipment can be made by combining simple and relatively cheap equipment and components, it is economical, and a secondary battery or a next-generation secondary battery such as an all-solid-state battery can be manufactured as a final product having high added value. Needless to say, it can also be applied to supercapacitors, multilayer ceramic capacitors (MLCCs), and all-solid-state batteries manufactured by the MLCC method.

In the present invention, when a slurry mainly composed of a particulate matter and a solvent is applied to a substrate or an object and the particulate matter is deposited on the substrate, it is performed while relatively moving the substrate and the spray device in a vacuum chamber or a closed small booth, the solvent can also be recovered by discharging only the volatile component of the solvent or a very small amount of gas added. In this case, the compressed gas is preferably a dry inactive gas such as nitrogen or argon in terms of safety and performance.

A method for further improving the prevention of sedimentation by applying WO2013/03953A1 filed and published by the present applicant, that is, a stirring device is set in two syringes to rotate and/or move vertically, when the vertical movement is switched, a jet is generated and mixed and dispersed, a slurry, which is composed of particulate matter with a specific gravity of 1.9 or more and a solvent with a specific gravity of 1 or less, and which has an extremely low viscosity of such as 50 mPa s (cps) or less or even 20 cps or less, and in which the particulate matter will precipitate instantaneously, is applied by moving pitch by pitch while offsetting the applicator and the substrate or the object, and the particulate matter can be laminated and applied in layers such as a desired layer of 2 to 50 layers in the form of a thin film. By forming multiple layers, even for particulate matter with a broad particle size distribution, a thin film layer of the particulate matter having an application weight per unit area within ±5%, preferably within ±1.5%, and having an even particle size distribution can be formed. As a result, it is possible to be applied to the object by setting the flow rate per unit time, for example, per second, of the particulate matter ejected to/on an object within ±5% of the set value, therefore the application weight can also be stabilized.

Needless to say, in addition to laminating the slurry on the substrate or the object to form a laminated body of the particulate matter, it can be achieved by laminating only the particulate matter for 5 layers or more, for example, up to about 50 layers in the form of a thin film. When the substrate or the object is a conductor, it is even better because even ultrafine particles can be densely adhered to the substrate or the object by being electrostatically charged. The substrate may be a scroll, a belt, or a roll.

As a result, the application weight stability is further improved by further adopting a method for increasing the number of times of application or coating layer to the object from the ejection port, for example, the method of WO/2011/083841 filed by the present applicant.

In addition, as described above, the substrate may be a disk, a cylinder, a flat plate, a block, a film, a coil, or the like, the shape, material, and size are not limited. To reduce the contamination of the substrate, it is preferable to use a ceramic material that has a high hardness and is of the same type as the particulate matter, or a ceramic material that does not cause abrasion or detachment of the substrate or a negligible level.

When the substrate is a metal plate, it is preferable that the surface is mirror-finished to facilitate the detachment of particulate matter, and a ceramic material may be coated or plated.

In addition, if it is porous, outside air can be introduced from the opposite surface of the suction surface when the particulate matter is sucked, and it can be transferred while being made into an ideal gas-powder mixture. The inactive gas can be introduced to the opposite side of the suction port of the porous.

In addition, the substrate may be provided with recesses on a disk, a block, or the like, and a screen or the like can also be used to fill the particulate matter or the slurry. When filling dry particulate matter, it is advisable to perform while applying vibrations such as ultrasonic waves to the substrate or the particulate matter multiple times to keep the bulk density constant. It can be applied as many layers as possible, for example, 5 layers, preferably more layers, on a film, a coil, or a sheet, by keeping the weight constant in advance, regardless of dry particulate matter particles or wet particulate matter particles such as a slurry. When the head and the substrate are relatively moved, in order to change the phase at a pitch of 10 mm or less, the offset may be set to 2 mm or less to perform the application. When using a particulate matter with a wide base of particle size distribution, the weight per unit area of the particulate matter is more stable when a conductor is used as the substrate or a conductive treatment is performed, and multiple layers are applied while changing the phase by static electricity or the like.

In addition, in the present invention, the particulate matter filled in the rotating and moving screen can be sucked and transferred. The particulate matter may be filled to the screen as a slurry or may be the particulate matter as it is. Further, a plurality of screens may be prepared, and multiple kinds of slurries or particulate matter may be independently filled and each of them may be laminated on the object downstream, or a slurry with multiple kinds of particulate matter being mixed may be formed and laminated on the object.

As described above, according to the present invention, the application, distribution, or film formation of a particulate matter to/on an object can be uniformly performed from a microscopic point of view. In addition, by applying it to the aerosol deposition, it is possible to perform high-quality film-formation for ceramics or the like at low cost. Further, it can be applied to other applications such as film formation in the electronics field or application of LED phosphors. In addition, by applying the present invention to a general thermal spraying method for ceramics, waste of materials can be reduced, and even a thin film with high accuracy can be formed, so that the polishing process can be omitted, therefore the market including cold spray and warm spray can be expanded.

### BRIEF DESCRIPTION OF DRAWINGS

FIG. 1 is a schematic cross-sectional view illustrating the present invention.

FIG. 2 is a schematic cross-sectional view according to an embodiment of the present invention.

FIG. 3 is a schematic cross-sectional view according to an embodiment of the present invention.

FIG. 4 is a schematic cross-sectional view according to an embodiment of the present invention.

### DESCRIPTION OF EMBODIMENTS

In the following, preferred embodiments of the present invention will be described with reference to the drawings. The following embodiments are given only for the illustrative purpose to facilitate the understanding of the invention, and not intended to exclude feasible additions, replacements, modifications made thereto by persons skilled in the art without departing from the technical scope of the present invention.

The drawings schematically show preferred embodiments of the present invention.

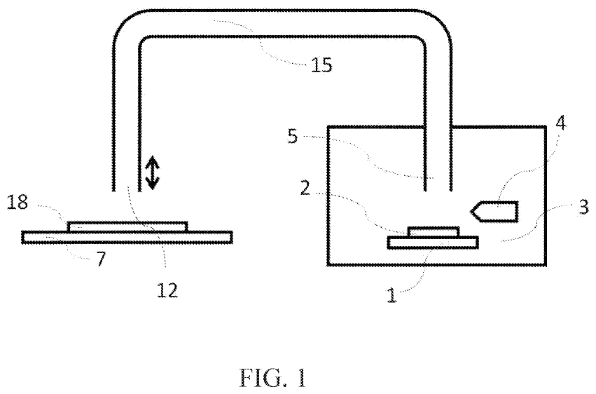

In FIG. 1, the substrate 7 is applied with the particulate matter 18 controlled at a constant weight per unit area. A guide for a constant weight is within ±5%, preferably within ±1.5% of the set value per square centimeter. For example, in the case of 0.6 mg per square centimeter, it is within ±0.03 mg or ±0.009 mg. The particulate matter can be easily sucked by bringing the suction port 12 close to or in contact with the surface of the particulate matter. The particulate matter is transferred from the suction port 12 to the ejection port 5 communicating with the suction port 12 by differential pressure and applied to the object 1 to form a coating layer or a film layer 2. The ejection port 5 may be a nozzle, and the shape may be round, square, slit groove, or the like, the shape and size are not limited, but it is preferable to select the ejection port 5 according to the shape of the object 1. As a means for making the weight per unit area on the substrate constant, the particle size distribution of the particulate matter can be uniformized and the weight per unit area can be made more stable and constant by coating multiple layers as many as possible, for example, in 100 layers. Alternatively, it is also possible to prepare a plurality of substrates applied with one layer or a plurality of layers and similarly prepare a plurality of suction ports and ejection ports to pursue the averaging per unit area. In addition, when it is ejected from the ejection port 5 to the object 1 and applied, the uniformity of the coating film weight per unit area of the particulate matter on the object 1 can be improved by coating not only one layer but also a plurality of layers, for example, 10 or more layers and reducing the weight per unit area as much as possible as in the example on the substrate 7. When it is coated to/on the substrate 7 or the object 1 in multiple layers, it is preferable to relatively move the application means and the substrate, further the suction port 12 and the substrate 7, or the ejection port 5 and the object 1. The differential pressure may be an ejector method, but the chamber 3 in which the object 1 is installed can be set to a negative pressure (vacuum), thereby the particulate matter can be sucked from the suction port 12 and applied to the object 1. The differential pressure is set to 50 kPa or more, and the ejection speed of the particulate matter is set to 150 m/sec or more to enable the collision and application on the object. Even if the ejection speed is not as high as 150 m/sec, and even if the fine powder is not preferably submicron or less, the particulate matter can be heated halfway with the heating means 3, and even if the particulate matter has a particle size of about 0.08 to 2 microns or more, at least some of the particulate matter can also be softened to enable the application or the film formation. Note that 50 kPa or more means a higher vacuum side. The differential pressure is not particularly limited. In addition, the atmosphere of the substrate 7 and the suction port 12 may also be set to a vacuum atmosphere if there is a differential pressure such as a differential pressure of 50 kPa or more, between them and the object 1.

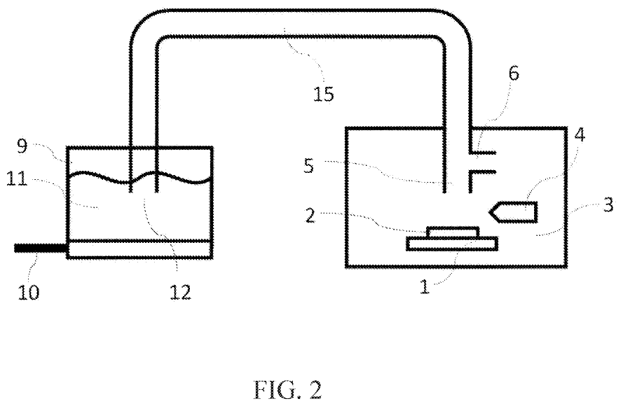

In FIG. 2, the particulate matter flows as the gas-powder mixture 11 with the gas ejected from the porous tank 9 provided in the flow tank. The inactive gas such as argon is supplied from the gas line 10. The fluidized gas-powder mixture 11 is sucked from the suction port 12, moves to the vacuum chamber 3, and is ejected from the ejection port 5 to the object 1.

The heating means 4 is installed between the ejection port 5 and the object to support the softening and melting of the particulate matter due to collision on the object 1. As the heating means, the flow path 15 such as a metal pipe having good heat conduction can also be heated by far infrared ray, induction heating, hot air, steam, a heat element, or the like to heat the moving particulate matter. It is important to prevent the particulate matter from melting in the flow path 15 and from adhering to the inner surface of the flow path 15. In addition, it is important to keep the heating temperature as low as possible so as not to impair the performance so that the components of the active material for electrodes of the battery do not deteriorate at high temperatures. When installing the heating means between the ejection port 5 and the object, it may be laser or electron beam, and the type of the laser is not limited, but when heating only the surface of the particulate matter, a femtosecond laser or a picosecond laser or the like is preferable. In addition, at the stage when the particulate matter is laminated and applied on the object 1, it can be irradiated with a femtosecond laser or the like to form a film by at least partially softening or melting for each lamination so as not to affect the components of the active material. In addition, the heating means can be selected and installed both in the flow path and downstream of the ejection port.

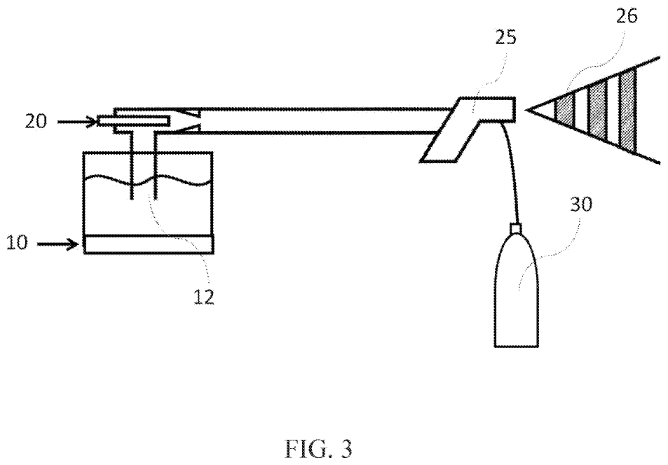

In FIG. 3, the particulate matter is sent to the thermal spraying gun 25 in a pulsed manner to stabilize the moving amount and to easily adjust the injecting amount per unit time from a very small amount to a large flow rate. Therefore, the particles are melted by the flame from the fuel gas 30 while being injected in a pulsed manner Melted particles adhere to the object (not shown) to form a film. The pumping or suction of the particulate matter is not particularly limited. The supply means for the particulate matter may be an ejector method or a supply form as shown in FIG. 1. The through holes of the substrate and the openings of the screen can be filled with particulate matter, which can be sucked and transferred.

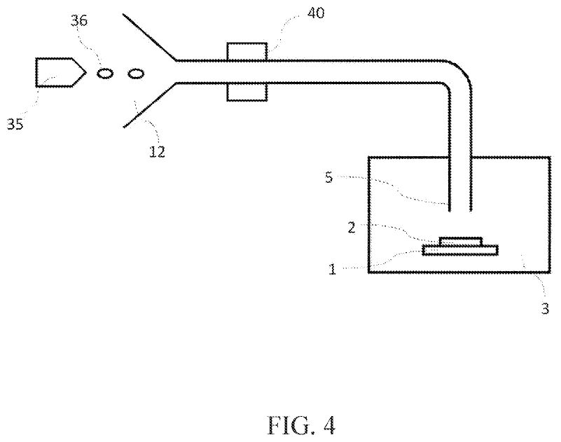

In FIG. 4, the particulate matter is made into a slurry with a solvent and discharged or sprayed from the applicator 35 toward the suction port 12 with fine droplets 36. The suction port 12 communicates with the ejection port 5, the injection port 5 and the object 1 are installed in the vacuum chamber 3, and the solvent of the slurry discharged or sprayed evaporates by the atmosphere of the vacuum chamber 3 or the heating means 40, diffuses in the vacuum chamber and is sucked by a vacuum pump. Only the particulate matter that does not contain a solvent, or the particulate matter that contains a small amount of solvent and has directionality, adheres to the object. Whether the solvent is contained or not can be adjusted by the heating means and the degree of vacuum. In addition, in this method, it is possible to select whether the particulate matter is softened or melted to form a film on the object or the particle is maintained as it is. When guiding slurry droplets of about 0.5 millimeters or less, spray fine particles with an average particle size of about 0.1 or less, or slurry fine particles generated by another fine particle generator to a vacuum chamber using a solvent for slurry having a low boiling point of about 100° C. or less, good results can be obtained even without using the heating means.

For example, the solvent used includes ketone-based acetone, MEK (methyl ethyl ketone), MPK (methyl propyl ketone), etc., alcohol-based ethanol, methanol, IPA (2-propanol), 1-propanol, etc., or hydrocarbon-based heptane (n-heptane), etc., and products that do not belong to PRTR method or Ordinance on Prevention of Organic Solvent Poisoning are preferable. Water can also be used.

In addition, by applying this method to a high boiling point solvent such as NMP (N-methyl-2-pyrrolidone), which is often used as a solvent for polymer binders in the field of secondary batteries, the solvent evaporation can be expected in a short time or instantaneously by azeotropic action with the low boiling point solvent. It is particularly suitable for NMP or the like having a boiling point of more than 200° C. as described above, regardless of whether it is heated or not. Especially when no heating means is used, the capacity of the vacuum pump for the vacuum chamber is required to be a capacity to maintain the vacuum degree of the vacuum chamber, for example, at 1 Torr, and to instantaneously discharge the compressed gas for spray flowing into the vacuum chamber and the outside air flowing in from the suction port. A capacity of at least 2 times or more, ideally 10 times or more for the suction amount is preferable. Commercial vacuum pumps such as FT4-65LE and FT4-150LE manufactured by ANLET, Co., Ltd can be used, which have a discharge speed of about 1 Torr and 0.2 M³/min or 1 m³/min even if the flow rate of the two-fluid spray gas is about 20 to 200 NL (normal liter) per minute.

This method is effective for the evaporation or solvent recovery of the high boiling point NMP and highly toxic DMF, which are solvents that dissolve binders such as vinylidene fluoride (PVDF) for the formation of electrodes in lithium ion secondary batteries or the like. A binder that does not adhere to the flow path and affect the application weight or the like may be added to the slurry.

In this method, the object can also be heated, and it can be laminated while colliding with impact by relatively moving the ejection port and the object, so that a uniform particulate matter layer with extremely few voids can be formed.

In addition, with the prior art, it has been impossible to microscopically and uniformly apply the particulate matter with a wide base of particle size distribution. It is extremely difficult to apply a thin film at one time with a variation of ±5% or less, preferably ±1.5% or less per unit area of at least per square centimeters or less, and even per square millimeters or less. Even with a sharp particle size distribution, when observed microscopically, parts of large particles and small particles naturally exist, and the shape cannot be said to be constant.

In the present invention, the weight per unit area of the particulate matter in the pre-step of application or film formation on the object is made constant. In order to make it constant, when applying the particulate matter in the pre-step to the substrate, the applicator, which is a part of the applying device for the particulate matter, and the substrate are relatively moved to perform application a plurality of times. Specifically, the first layer is applied while the substrate is moved pitch by pitch and the applicator is traversed. Next, the phases of the pitches are shifted, and the second layer, the third layer, and so on are overlaying applied. The applicator may be moved pitch by pitch and the substrate may be traversed, or they may be alternated to pursue a more uniform application weight. In addition, regardless of whether the coating material is a particulate matter or a mixture with a solvent, the application method and means are not limited, but pulsed spray is preferable because the application efficiency can be increased. Furthermore, if at least the application portion of the substrate is grounded and static electricity or the like is applied to the particulate matter or the slurry to charge and perform application, even fine powder can be adhered, so that the uniformity is further increased. It is effective to attach a solvent or the like that is easily charged to the particulate matter that is difficult to be charged.

By doing so, it is possible to make the weight per unit area and even per micro unit area uniform also from the viewpoint of probability.

In addition, the present invention is not limited to applying a mixture composed of a plurality of kinds of particulate matter and short fibers or a slurry thereof on a substrate in multiple layers by using a single applicator, it is also possible to laminate and apply a plurality of particulate matter and slurries in multiple layers by using a plurality of applicators.

In addition, according to the present invention, a plurality of particulate matter and slurries can be applied to a plurality of substrates by using a plurality of applicators, and if necessary, the gradient application that changes the desired mixing ratio of particulate matter in the thickness direction of the coating film is performed, and the particulate matter on each substrate can be applied to/on the object in a desired order in multiple layers. The suction port and the ejection port may be provided one for each, or may be provided for each type of particulate matter.

When the object is an object for a secondary battery, for example, a collector and the particulate matter are active material particles, conductive assistant particles or fibers, the plurality of particulate matter or fibers can be laminated on the collector. It may be laminated by different application means, or it may be mixed in advance and laminated. A binder such as PVDF or rubber, or an organic electrolyte resin for a polymer battery, or the like can be extremely thinly encapsulated or partially adhered to active material particles, conductive assistant particles, or fibers. At least the binder or the like can be softened by a heating means in the state of particulate matter or fiber to form a film together on the collector. Even if the heating means up to the object is not used, the object may be heated above the softening point of the binder to form a film. As the application means, an electrostatic coating method such as corona discharge, triboelectric charging, or combination thereof can be used. The binder or the like may be made into particles or fibers, mixed with the active material particles and applied, and can be independently laminated. In the case of independent laminating after film formation, the laminating order may be started from any of them, and in the laminating step, the ratio of the conductive assistant or the like can be changed in order from the collector so that the ratio changes in a gradient manner.

In addition, by keeping the weight per unit area as low as possible and freely combining them and laminating them as thinly as possible in multiple layers, uniform and ideal mixing of multiple kinds of materials can be achieved. In the present invention, the particulate matter or fiber can be directly applied to the substrate or the object. In addition, each of them can be made into a slurry and laminated independently. Further, they also can be mixed and laminated.

In addition, when applying a particulate matter or a slurry to/on a substrate or an object with an applicator, the substrate and the applicator are relatively moved, one of them is fed at a desired pitch, and the other is traversed to enable the application on the substrate or the object, the second and subsequent layers are offset and two or more layers (for example, 10 layers) are applied at a dense pitch (for example, a pitch of 1/10 of the desired pitch), so that the application distribution of the particulate matter is more uniformized. In addition, the substrate or the object may be a cylinder or a film or foil wound around the cylinder, and the cylinder can be rotated. In addition, the film may be a porous film such as a secondary battery separator, and the foil as a collector has an electrode formed on it and the electrolyte polymer is melted on the electrode, or is made into a solution or an emulsion with an organic solvent or the like, or is made into particulate matter or fibers, and further, the particulate matter or the like is made into a slurry and applied, thereby an electrolyte layer can be formed. The substrate or the object can be moved intermittently or continuously by a roll-to-roll method.

Similarly, in the present invention, the positive electrode of the all-solid-state battery can be formed on the collector and the negative electrode can be formed on another collector by the above method, and at least the solid electrolyte particles are softened on either or both of them, applied and crimped to form an all-solid-state battery cell, further, an all-solid-state battery can be manufactured. The binder may or may not be used.

According to the present invention, it can be applied not only to lithium-ion secondary batteries or next-generation secondary batteries such as all-solid-state batteries or all-solid-state air batteries, but also to fuel cells, especially SOFCs, or supercapacitors and other storage batteries. It can be applied to the thermal spraying fields, semiconductors, electronic parts, biotechnology, and pharmaceutical fields that require powder coating, micro-distribution and application of particulate matter, and if applied to the aerosol deposition process, the adhesion amount can be expected to approach 100% as much as possible with respect to the conventional adhesion amount of about 10%, and it can be performed with high quality and low cost.

### DESCRIPTION OF THE REFERENCE NUMERAL

1 substrate
2 coating film
3 vacuum chamber
4 heating means
5 ejection port
6 branch port
7 substrate
9 fluidization hopper
10 gas supply line
11 gas-powder mixture
12 suction port
18 particulate matter
20 ejector
25 thermal spraying gun
26 thermal spraying injection pattern
35 applicator
36 droplets or spray particles
40 flow path heating means

1. An application or film formation method for a particulate matter by pumping a particulate matter or sucking the particulate matter from a suction port, transferring the particulate matter, ejecting the particulate matter from an ejection port toward an object, and softening at least some of the particulate matter to enable the application or film formation on the object, comprising:
a step of providing a pumping means or a suction port for the particulate matter and an ejection port for the particulate matter, the ejection port communicating with the pumping means or the suction port,
a step of transferring the particulate matter by differential pressure between the pumping means or the suction port and the ejection port to eject the particulate matter from the ejection port toward the object,
a step of keeping ejection weight per second of the particulate matter within ±5% of a set value,
a step of setting the object downstream of the ejection port, and
a step of providing a heating means for the particulate matter between the pumping means or the suction port and the object, wherein:
at least some of the particulate matter colliding with the object is at least softened or melted.

2. The method according to claim 1, wherein at least the ejection port for particulate matter and the object are arranged under vacuum, so that the differential pressure is generated between the ejection port and the suction port or the pumping means for particulate matter.

3. The method according to claim 1, wherein the particulate matter is transferred or ejected in a pulsed manner.

4. The method according to claim 1, wherein the particulate matter to be transferred is at least one selected from: those fluidized as a gas-powder mixture; those for which a slurry comprising the particulate matter and at least a solvent is formed, and finely dropletized or micronized by a fine particle generator; those applied on a substrate in advance; and those filled in a body provided with a recess or a through hole in advance.

5. The method according to claim 1, wherein a branching means provided with a branch port is installed upstream of the ejection port for particulate matter, and surplus gas is discharged from the branch port while the particulate matter is ejected from the ejection port toward the object.

6. The method according to claim 1, wherein the suction port or the pumping means for particulate matter is installed in a first vacuum chamber, at least the object and the ejection port are installed in a second vacuum chamber, and degree of vacuum in the second vacuum chamber is high.

7. The method according to claim 4, wherein the particulate matter on the substrate or the particulate matter filled in the body is mixed by adding at least a solvent to the particulate matter to form a slurry, then applied or filled and dried.

8. The method according to claim 1, wherein the heating means for particulate matter is at least one selected from laser, electron beam, microwave, induction heating, plasma, flame, far infrared ray and a heater.

9. The method according to claim 1, wherein the object is heated at least when the particulate matter is ejected.

10. The method according to claim 5, wherein the branch port and the ejection port are installed under vacuum, the particulate matter between the ejection port for particulate matter and the object is heated with the heating means for particulate matter, or only the surface of the particulate matter applied to the object is heated with the heating means, and at least the particulate matter being laminated is softened or melted.

11. The method according to claim 1, wherein the particulate matter contains short fibers, and is composed of a mixture of multiple kinds of particulate matter.

12. The method according to claim 1, wherein the particulate matter contains short fibers, and multiple kinds of particulate matter are prepared, each of which is provided with an independent pumping means or suction port and an independent ejection port for particulate matter, and each of the particulate matter is mixed downstream of the ejection port, or ejected to the object with a time difference, or ejected so as to laminate at different positions, and laminated.

13. The method according to claim 1, wherein the object is selected from a collector for a secondary battery, a positive electrode or negative electrode layer, a separator, and a polymer electrolyte layer.

14. The method according to claim 12, wherein the object is selected from a collector for an all-solid-state battery, a positive electrode or negative electrode layer, and an electrolyte layer, and the plurality of particulate matter also contain short fibers and are selected from active material particles for a positive electrode or a negative electrode, electrolyte particles, conductive assistants, and binders.

15. The method according to claim 1, wherein a layer composed of a binder or a mixture of a binder and the particulate matter is formed on the object in advance.
